(19) United States
(12) Patent Application Publication
(10) Pub. No.: US 2018/0197167 A1
(43) Pub. Date: Jul. 12, 2018

(54) SYSTEM AND METHOD FOR PERSON-TO-PERSON PAYMENTS

(71) Applicant: Early Warning Services, LLC, Scottsdale, AZ (US)

(72) Inventor: Ravi Ganesan, San Diego, CA (US)

(73) Assignee: Early Warning Services, LLC, Scottsdale, AZ (US)

(21) Appl. No.: 15/403,560

(22) Filed: Jan. 11, 2017

(51) Int. Cl. G06Q 20/22; G06Q 20/40; G06Q 20/04; G06Q 20/24; G06Q 20/32; G06Q 20/10; G06Q 20/02

(52) U.S. Cl. CPC G06Q 20/223; G06Q 20/4016; G06Q 20/405; G06Q 20/02; G06Q 20/24; G06Q 20/3226; G06Q 20/108; G06Q 20/042

(57) ABSTRACT

A person-to-person (P2P) payment system provides payment from a payer to a payee without the payer identifying a payee payment receiving preference, such as the payee account into which funds are to be posted. The payment system includes a setup system for setting up payment between the payer and the payee and a messaging system for handling messages between the payer and the payment system and the payee and the payment system, including communications with the payee by way of a payee phone number or email address provided by the payer. A risk assessment system determines a risk score for the P2P transaction and, based on that score, the bank of the payer provides a guarantee to the bank of the payee.

### BACKGROUND OF THE INVENTION

Person-to-person (P2P) payment systems have become popular for transferring money between individuals. P2P payment systems provide many benefits, including convenient transfer of payments, as well as providing accessible electronic records of the payments. However, many P2P payment systems require that both the person making payment (payer) and the person receiving payment (payee) be enrolled with the system. Enrolling typically includes providing preferences, such as the payer account from which payment funds will be taken and payee account to which payment funds will be deposited.

The convenience of P2P payments is affected, however, when both parties have not already enrolled or pre-registered with the payment system. In those circumstances, one party (usually the payee) will need to go through the process of enrolling and providing preferences prior to receiving payment, which can delay the receipt of payment. Since the number of different P2P payment systems has increased in recent years, a payee may need either to have pre-registered or to register at the time the payment with a number of P2P providers, depending on which provider and system is being used by the payer. Some consumers are hesitant to provide financial information (such as account preferences) to a number of different entities because of the risk that such information might compromised (e.g., by hackers surreptitiously gaining access to the payment systems). Thus, a payer (or payee) may prefer to conduct most if not all of the payers transactions using only one or two preferred payment systems (to limit the risk that financial information might be compromised), which payment systems may not be the payment system preferred by the other party.

While some P2P payment systems may permit a payer to enter payee account information (so that the payee need not be registered with the system), the extra steps required of the payer to conduct the transaction (knowing how the payee would like to be paid and providing that information to the system) make the system less convenient for the payer to use.

Further, some consumers simply do not want to receive payments electronically, but rather prefer being paid either in cash or by check. Where a payee has not registered or does not want to register with a P2P system, a payer is not be able to achieve the benefits of using a P2P payment system.

Thus, current P2P payment systems are not always able to achieve features and advantages for which they are designed.

### BRIEF SUMMARY OF THE INVENTION

There is provided, in accordance with embodiments of the present invention, a network/system and method for providing for person-to-person payments, where payment can be provided to any payee (whether pre-registered or not) based on the preferences of the payee, but without the payer needing to know those preferences or having to provide them for purposes of completing the transaction.

In one embodiment, a person-to-person payment system for providing payment from a payer to a payee using a mobile device of the payer includes a payment setup system and a risk assessment system. The payment setup system is programmed for: enrolling the payer, including receiving from the payer an account identifier for identifying an account of the payer that is used to fund payment from the payer to the payee; receiving, through a payment messaging system, a payment request message from a payer device, the payment message request including a payment amount and payee identification information, the payee identification information including at least one of a payee phone number, a payee email address and a payee mailing address; determining whether the payee phone number and the payee email address have been provided, and whether at least one of the provided payee phone number and payee email address is usable to communicate with the payee; upon determining that the at least one of the provided payee phone number and payee email address is not usable to communicate with the payee, determining that a payee mailing address has been provided as part of the payee identification information, and generating correspondence to the payee using the payee mailing address; upon determining that the at least one of the provided payee phone number and payee email address is usable to communicate with a payee, sending an electronic communication through the payment messaging system to the payee device requesting that the payee select one payment method from a group of payment methods for receiving payment from the payer, the group of payment methods comprising: 1) receiving a paper check, 2) receiving a check image electronically, and 3) receiving an electronic deposit to an account of the payee; after selection by the payee, as the one payment method, for receiving a paper check or for receiving a check image electronically, providing the paper check or the check image to the payee; and after selection by the payee, as the one payment method, for receiving an electronic deposit to an account of the payee, receiving at the payment settlement system from a payee device an account identifier for identifying the account of the payee. The risk assessment system is programmed for: receiving from the payment settlement system at least the identifier for the identified account of the payer and the identifier for the identified account of the payee; and generating, in response to receiving the identifiers for the identified account of the payer and identified account of the payee, a risk score reflecting the degree of risk associated with the requested payment from the identified account of the payer to the identified account of the payee, and providing the risk score to a first financial institution maintaining the identified account of the payer. The payment system receives, from the first financial institution maintaining the identified account of the payer, and in response to the risk score, a message having a payment guarantee for the amount of the payment to a second financial institution maintaining the account of the payee, the payment guarantee based at least in part on the risk score. The payment guarantee is provided to the second financial institution maintaining the identified account of the payee in order to immediately credit the identified account of the payee with at least a portion of the amount payment.

A more complete understanding of the present invention may be derived by referring to the detailed description of the invention and to the claims, when considered in connection with the Figures.

### BRIEF DESCRIPTION OF THE DRAWINGS

FIG. 1 is a general block diagram illustrating one embodiment of a payment settlement system for making person-to-person payments between a payer and a payee.

FIG. 2 is a flow diagram illustrating the overall operation of the payment settlement system of FIG. 1, including interaction with a payer and payee.

FIG. 3 illustrates a display screen at a payer device in response to messaging between the payment settlement system and the payer device, for purposes of entering payment information by the payer.

FIG. 4 is a message displayed at a payee device, for the payee to provide selection of a method of payment through the payment settlement system.

FIG. 5 is a diagram illustrating messaging between a payer device, a payment settlement system, a payer financial institution system, a payee device and a payee financial institution system, for purposes of implementing a person-to-person payment.

FIG. 6 is a block diagram illustrating an exemplary computer system that is specially designed and programmed in order to implement various features of the invention.

### DETAILED DESCRIPTION OF THE INVENTION

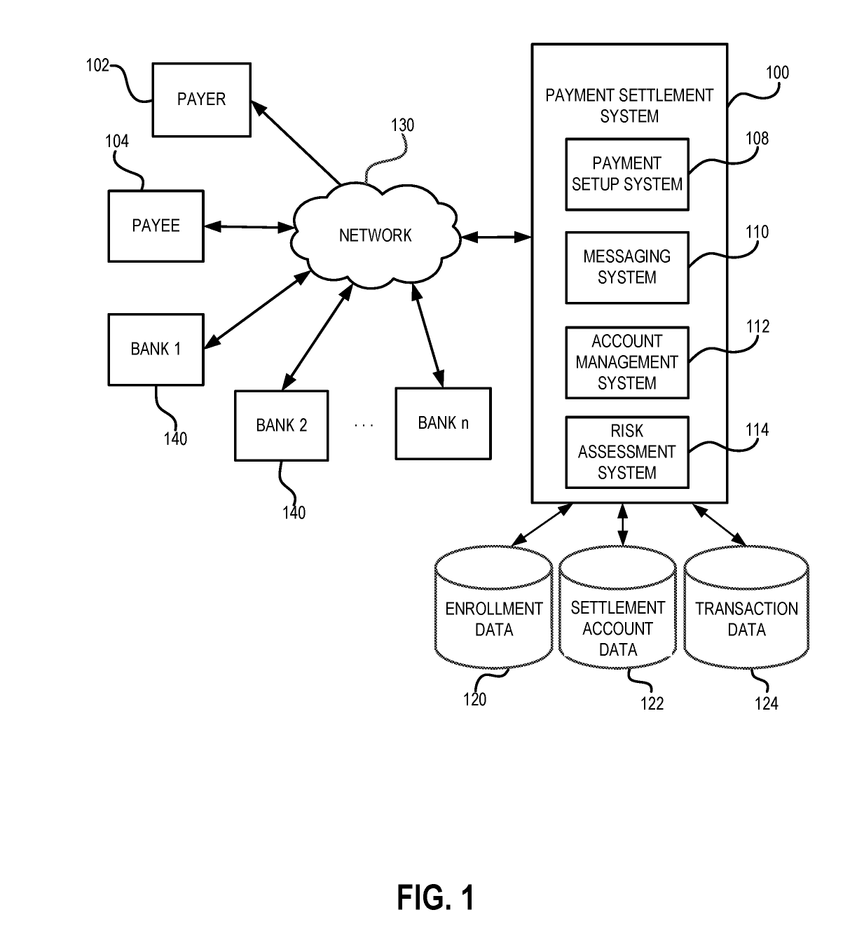

There are various embodiments and configurations for implementing the present invention. One such implementation is shown in FIG. 1, where according to an embodiment of the invention, a payment settlement system 100 facilitates payment transactions between a payer 102 and a payee 104. In described embodiments, the system 100 is a of a type commonly referred to as a “person-to-person” (P2P) payment system, although it should be understood that in some embodiments the payer and payee may be an entity rather than a person or individual (e.g., a merchant entity either receiving payment as a payee from a customer or that same merchant entity making payment as a payer to a supplier).

The payment settlement system 100 includes a payment setup system 108 for setting up payment in response to payment information from a party to a transaction, a messaging system 110 used for receiving and generating messages as part of the payment process, an account management system 112 for managing information provided during enrollment and for maintaining a settlement account between banks (for purposes to be described in greater detail later), and a risk assessment system 114 that may be used to assess the risk of any payment transaction (for purposes also to be described in greater detail later). The payment settlement system 100 also maintains and manages several memory or database systems in order to carry out its functions, the databases including an enrollment database 120, a settlement account database 122, and a transaction database 124. In some embodiments, the databases 120, 122 and 124 may be accessed at a location remote from the payment settlement system 100.

The payment settlement system 100 communicates with the payer and payee over a communications network 130, which may include the Internet, dedicated telecommunications networks, or combinations thereof. The payer and payee may communicate with the network 130 using various electronic devices, such as mobile smart phones, personal computers, tablet computers and other similar devices, although in some embodiments, as will be described later, one party (e.g., the payee 104) may use the payment settlement system 120 for purposes of receiving payment without the use of an electronic device.

Also illustrated in FIG. 1 are systems at a plurality of banks 140 (Bank 1 through Bank n), any one of which may maintain an account of the payer 102 (from which payment may be sent) and or an account of the payee 104 (into which payment may be deposited). It should be appreciated that while the term “bank” is used in conjunction with FIG. 1, banks 140 need not be traditional banks, but rather may be any financial institution or other entity that maintains accounts accessible to a payer or payee, such as credit unions, savings and loans, investment firms, credit card companies, government agencies, insurance companies and the like.

The operation of the various systems illustrated in FIG. 1 will be described in greater later in conjunctions with other figures. Briefly, when a payer 102 wants to make payment to a payee 104, the payer accesses the payment settlement system 100 over the network 130. The access may be facilitated by an application resident on a payer device or through a website that interfaces with the payment settlement system 100. It is assumed for purposes of the present discussion that the payer 102 has previously enrolled for using the P2P service implemented at the payment settlement system 100, and has provided payment preferences (such as one or more accounts to be used by the payer to fund payments). As such, the payment setup system 108 retrieves, from the enrollment database 120, the account of the payer that will be used to fund the payment.

Through various messages handled by the messaging system 110, the payment settlement system 100 determines how to contact the payee 104 and determine how the payee would like payment made. One feature of the present invention is that the payee need not be enrolled with the payment settlement system, but rather can be reached through a phone number, email address or physical address provided by the payer 102. The payee can select, for example, payment to be made into a payee account at one of the banks 140, using the messaging system 110. As another example, the payee 104 may elect to receive a paper check through the mail. When the payee elects to have funds automatically or electronically transferred to an account, the risk assessment 114 may be used to assess the risk of the transaction. This risk assessment may be used by the bank of the payer to determine whether it is willing to guarantee (or make “a promise to pay”) the amount to the bank of the payee. Risk assessment may be accomplished, for example, by accessing the transaction database 124, which may include data pertaining to any payer account(s), any payee account(s), and transactions at those accounts. Based on analysis of that data, the risk assessment system can develop a risk assessment or score related to the payment transaction. The transaction database 124 may collect data across many financial institutions (such as banks 140) and accounts at those institutions, in order to have access to sufficient data to develop a risk assessment. One example of a risk assessment system and related databases can be found in U.S. Pat. No. 8,682,766, issued to Robin S. Love et al., commonly owned with the present application, and hereby incorporated by reference. The transaction database 124 may also store (for use independent of the risk assessment system 114) P2P payment transactions completed by the system 100 (e.g., stored as a record accessible by the payer or payee).

In alternative embodiments, where a less comprehensive risk assessment is acceptable, the risk assessment system 114 may simply request a “good funds” response from the payer bank, namely that the payer has sufficient funds in the account being used to fund the amount of the payment and that such amount has been either debited for the benefit of the payee or has been subjected to a “hold” so that the funds are committed for the P2P payment. In some embodiments, a “good funds” response may be used as part of broader risk assessment at the system 114, e.g., even though sufficient funds are available in the payer account, other elements of risk, such as the risk that someone other than the payer is attempting to make payment using the payer's identity, might be desired by the banks/parties involved.

The account management system 112 may be used to manage settlement accounts between the banks 140. For example, if the bank of the payee immediately credits the payee account based on a payer bank's guarantee or promise to pay, a settlement account between those two banks receives a credit for the payee bank, and a debit for the payer bank. The payment settlement system may reconcile the settlement account, for example, at the end of each day, such that any transfers posted between two banks (whether credits or debits) are accounted for, and a payment can made by any one bank to another bank in order to bring their settlement account to a zero balance.

It should be noted that the functions performed by payment settlement system 100 as just described relating to facilitating payments between a payer and a payee offer numerous advantages to the payer and payee, as well as improved and efficient operation of computing devices making up the payment settlement system 100. For example, the payer need not know the method by which the payee would like to receive payment, but simply identifies a method of communicating with the payee in order for the payee to make that selection. Furthermore, the payee need not have registered or pre-enrolled with the payment settlement system, but only needs to interact with the payment settlement system when it wants to be paid and then only one time for purposes of receiving a payment. Furthermore, when a payer bank determines that the transaction is an acceptable risk level (as determined by the risk assessment system 114), payment can be immediately credited to a payee account for access by the payee, with the settlement account between the payer bank and payee bank reconciled later to take into account any such payments.

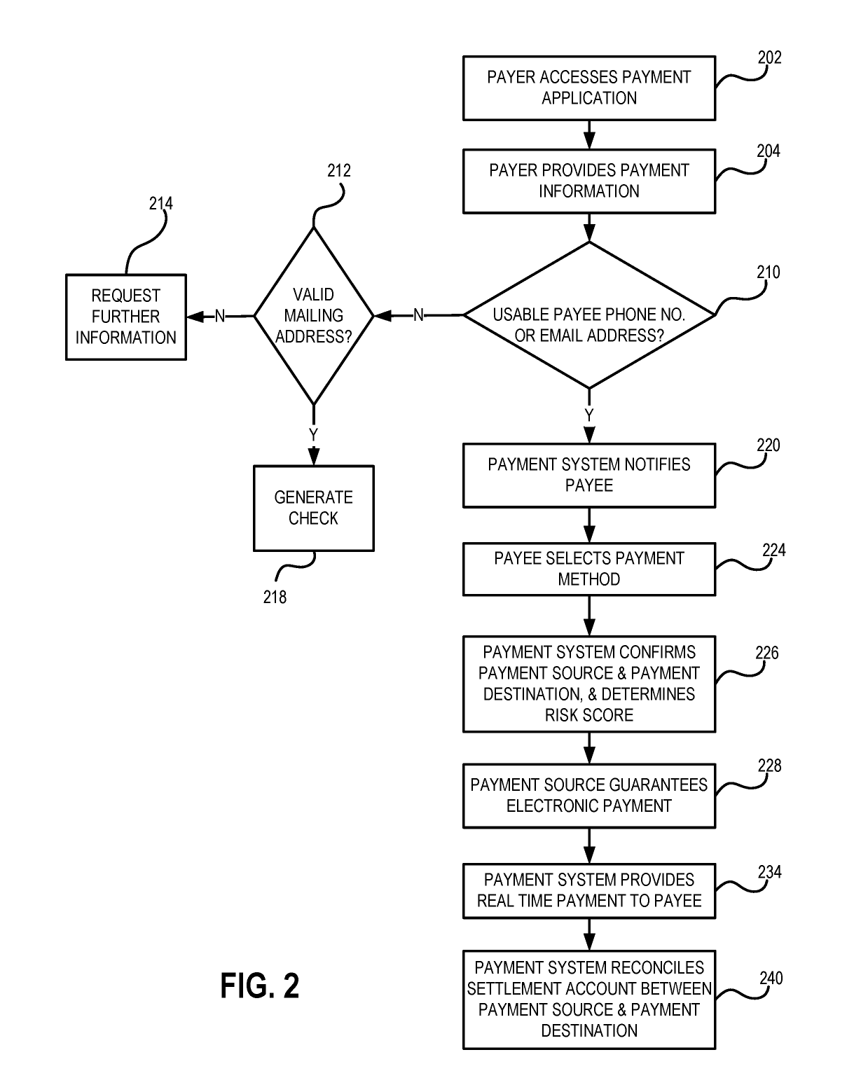

Turning now to FIG. 2, there is illustrated in greater detail a process implemented at the payment settlement system 100 for making a P2P payment between a payer 102 and a payee 104. The process may be implemented by one or more applications (uniquely designed as described herein) running at the payment settlement system 100. It is assumed, for purposes of this description, that the payer 102 has previously enrolled with payment settlement system and has provided various personal and identifying information, including the payer's preferences, such as a bank account from which funds are withdrawn to make the payment.

At step 202, the payer uses a device (such as a mobile smart phone) to access the payment settlement system 100. As mentioned earlier, access may be accomplished, as examples, through an app on the payer device or through a website hosted at a server at the payment settlement system. Alternatively, the payer may have a P2P service provided by the payer's bank (one of the banks 140), and access to the payment settlement system may be by way of the payer bank website. As an example, the operator of the payment settlement system 100 may be a third-party that offers, through member banks, a P2P service that can be used by any customer of those member banks.

As part of step 202, the payer may provide a username and password that permits the system to authenticate the payer and also retrieve personal information and preferences of the payer from the enrollment database 120.

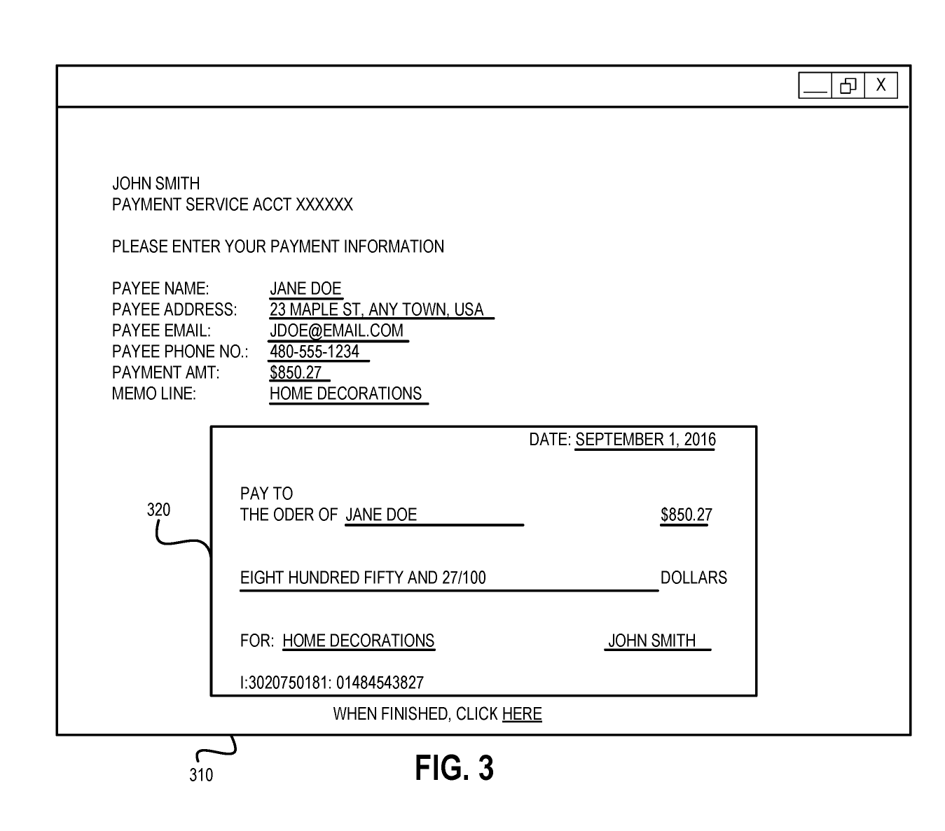

At step 204, the payer provides payment information through the network 130 to the payment settlement system. The payment information in one embodiment could be the name of the payee, the amount of the payment, and one or more of a physical address of the payee, an email address of the payee, and a phone number the payee. An example of a screen that appears on the payer's device for purposes of entering payment information is illustrated in FIG. 3.

In the embodiment of FIG. 3, and input screen 310 provides various visual prompts for entering information and displays the entered information as it might appear on a check made out to the payee. In this example, the payer (John Smith) maintains a payment service account at the payment settlement system (identified by a payment service account number). Various information concerning the payer is associated with the payment service account number (in enrollment database 120), including the preferred account at one of the banks 140 from which the payment is to be made. As illustrated, as the payer enters various information (payee name, payee address, payee email address, payee phone number, payment amount and memo line), and some or all of that information may be auto-populated onto an image 320 of a check. While in most transactions a paper check will not be sent to the payee, the display check image provides a familiar format for the payer to confirm details of the payment being made. However, as will be described shortly, in some cases, depending on the selection made by the payee, a paper check resembling the check image 320 could be provided to the payee.

As noted earlier, one important feature of the payment settlement system 100 is its operation that permits payment to a payee, regardless of whether the payee has registered with the system and regardless of whether the payer has any information on how the payee prefers to be paid. This operation is largely carried out by the functionality and underlying messages transmitted and received at the system 100 that are represented by steps 210-234 in FIG. 2, and implemented within the system 100 by the payment setup system 108 and messaging system 110.

At step 210, the system determines the nature of the identifying information that has been provided about the payee from the payer, and in particular whether a usable phone number or email address has been provided. The system 100 will generate (to the payee) a mobile message (e.g., SMS text message) if a usable mobile phone number is provided or generate an email message if a usable email address is been provided (or in some embodiments, generate both). If neither a usable phone number or email address is received from the payer at step 210, then the system determines whether a valid physical mailing address has been provided, step 212. If no valid mailing address is provided at step 212, then the system sends a message back to the payer requesting the needed contact information for the payee, step 214.

It should be appreciated that when the payer provides payment information, such as through the use of the input screen seen in FIG. 3, the payer can be required to provide at least one of a physical address, email address or mobile phone number in order to initiate the payment process, and be informed by a display on that screen (not shown) that the method of payment may be based on the information provided. In some embodiments, the input screen 310 may have associated scripts running in the background that will not permit the payer to submit the information unless the payer has provided at least one of a phone number, email address or physical mailing address. The payment setup system (through messaging between the payer device and the system 100) can check provided information and verify that it is usable, such as by accessing external third-party telephone, email address and post office databases (not shown).

If a valid physical mailing address has been provided at step 212, then the system 100 automatically prints a check (similar to the check image 320 in FIG. 3) at an associated printing system (not shown) and sends that check (e.g., via mail) to the payee at the mailing address provided, step 218. In some embodiments, the system 100 may first print and mail to the payee a letter informing the payee that a check will be sent absent hearing back (e.g., the letter may show a phone number for the payee to call and request some other form of payment, if a check is not desired).

If a usable phone number or email address has been provided at step 210, then the payment system 100 generates an electronic message (at messaging system 110) to the payee informing the payee of the payment that is being made by the payer, step 220.

It should be noted that in some cases, the payee may have previously enrolled with the system 100, even though not required for purposes of receiving payment. In such case, identifying information (such as a phone number or email address) provided at step 204 may be used to look up the payee account and the payee's preferences for receiving payment (e.g., at the enrollment database 120).

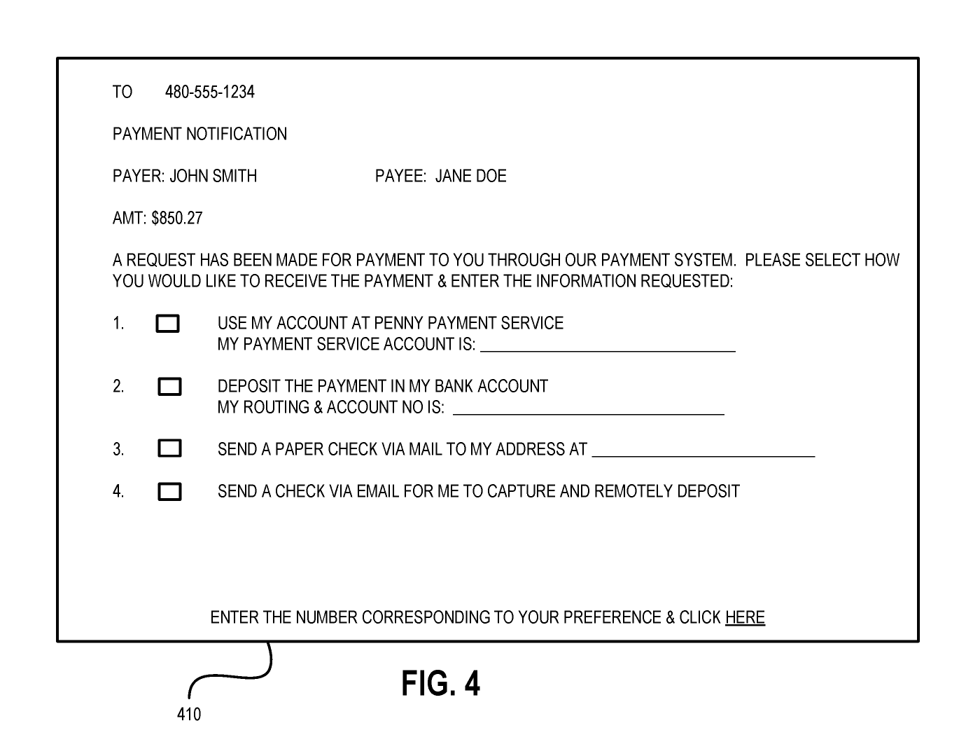

An example of a message (such as a text message) sent to the payee at step 220 is seen in FIG. 4. This message 410 includes information on the payment (including the payer and the amount) and requests that the payee select the method through the payment is to be made, step 224. As seen in the exemplary message of FIG. 4, if the payee has previously enrolled with the payment service (and has a payment service account associated with at enrollment), the payee can provide, at option 1, a payment service account number (the payment amount will be credited to a stored value or holding account at the payment service for later withdrawal or use by the payee). If the payee would prefer to have an electronic transfer of the payment, such as by an ACH transaction, crediting the payment to a bank account of the payee, the payee can select option 2 and provide a bank routing and account number, identifying the account into which the payment is to be deposited. If the payee prefers a paper check be mailed, the payee can select option 3. If the payee prefers a check to be emailed to the payee, then option 4 is selected. Option 4 permits the payee to either print a paper check from the returned email or use an image of the check for remote electronic deposit to a bank account using the payee's device.

Returning to FIG. 2, and in response to the selection made by the payee at step 224, a message is returned to the messaging system 110 and the pertinent data is provided to the payment setup system 108 in order to confirm the details of the payment, step 226. The confirmation by the system may include confirming the payment source account (the status of the account of the payer and its balance to make sure there are sufficient funds, such as by sending a bank balance query message to the payer's bank), confirming the payment destination account (such as by sending an account verification query to the payee's bank to confirm the that payee account and the payee personal information provided by the payer is consistent with information associated with the payee account), and obtaining a risk score associated with the proposed transaction (calculated by the risk assessment system 114).

As described earlier, the risk assessment system 114 may use transaction account data associated with any payer account and any payee account to assess the risk of fraud or other improper/illegal activity associated with the payment (i.e., evaluate account status and past transaction data posted to the accounts being used, and also data posted to any other accounts held by the same payer and payee). A confirmation message may be sent at step 226 to the payer bank and, assuming that the risk score indicates an acceptable level of risk to the payer bank, the payer bank will guarantee payment to the payee bank (in order to permit the payment settlement system 100 to immediately credit the amount to the payee account, assuming that an electronic funds transfer is involved). The payer bank generates a return message to the payment settlement system indicating the guarantee or promise to pay, step 228. In response to the guarantee or promise to pay by the payer bank, the payment settlement system 100 sends a message to the payee bank indicating the payment may be immediately credited, step 234.

For purposes of implementing these steps, it is assumed that the banks connected to the payment settlement system through the network 130 have each agreed to accept payment guarantees and immediately credit accounts based on those guarantees, and have further agreed that the guarantees or promises to pay between banks will be managed by settlement accounts managed by the payment settlement system 100. These settlement accounts are managed and maintained by the account management system 112 and the settlement account database 122. Finally, at periodic intervals (e.g., at the end of each day), the account management system 112 of the payment settlement system reconciles the settlement accounts between the banks step 240. As mentioned briefly earlier, each bank connected to system 100 has a settlement account with every other bank so that, for example, the amounts of promises to pay (guaranteed payments) between the two banks are credited to the settlement account (for the bank receiving the guarantee) and amounts deposited to a payee account are debited from the settlement account (for the bank making the guarantee). The two banks associated with each settlement account will transfer money to one another depending on guarantees and payee deposits during that day, in order to balance out the account (essentially, trying to achieve a zero balance at the end of the day), so that each bank owes nothing to the other after reconciliation).

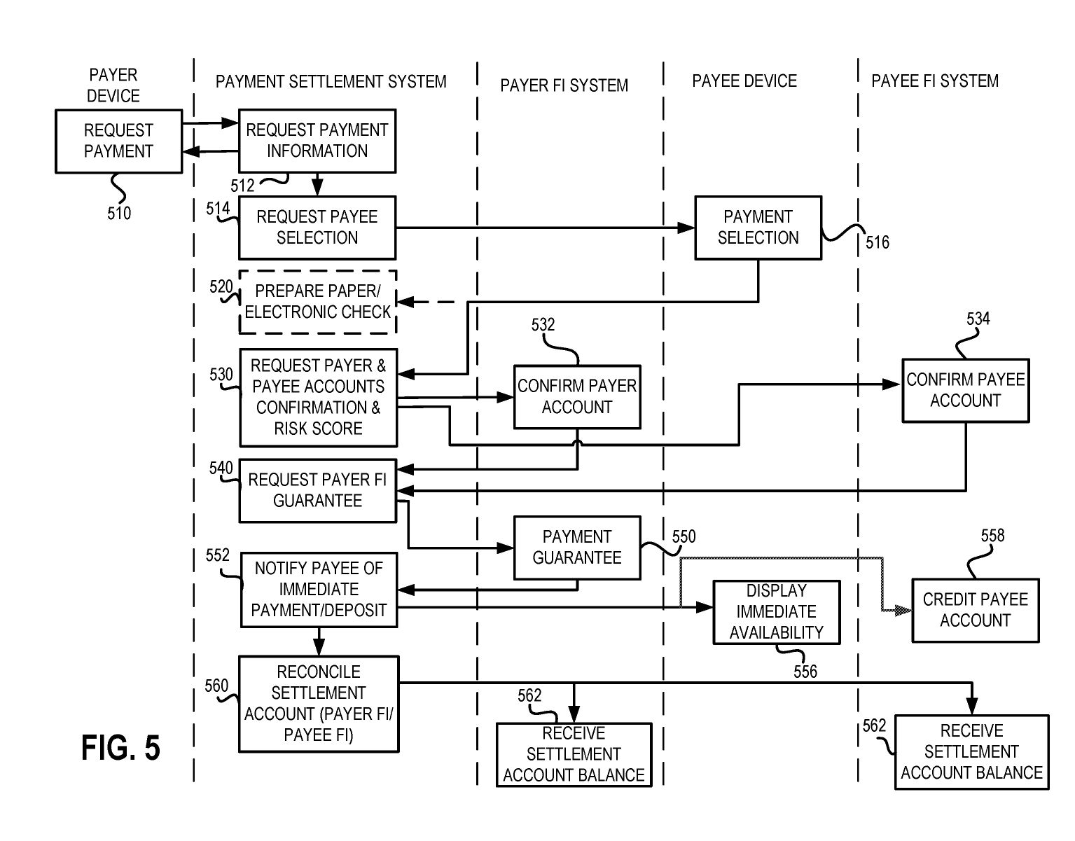

Turning now to FIG. 5, there is illustrated in greater detail the messages that are handled by the messaging system 110 of the payment settlement system. The particular messages shown are important to the operation and efficiency of the described payment settlement system 100, and as mentioned earlier, permit payment by the payer without needing to know the method by which the payee would like to receive payment.

The initial message sent to the payment settlement system is a payment request message 510 from the payer device (e.g., mobile device). The payment request message initiates the process seen in FIG. 2, and the payment settlement system generates a request 512 for payment information, including payee information, such as by sending a message back to the payer device to cause an input screen to appear on the payer device (as illustrated in FIG. 3).

Once the payment settlement system has received information on the payment from the payer device, a request message 514 is made to the payee from the payment settlement system for selection of the payment method. The request is sent to the payee device, where the payment selection is made and a reply message 516 is returned to the payment settlement system. It should be noted that the messages to be described assume that an electronic transfer will be made to the payee and that a phone number or email address of the payee has been provided by the payer. However, as indicated in dotted lines at message 520 in FIG. 5, in the event no phone number or email address is been provided (and the payee is contacted only by mail sent to the payee address), or if payment selection at the payee device (message 516) requests a paper check or image of a check be sent to the payee, such paper or electronic check is requested at message 520 by the payment settlement system.

When an electronic transfer of funds to the payee is selected (at the payment selection message 516) and sent to the payment settlement system, the payment settlement system generates a message 530 requesting confirmation of the payer and payee accounts (from the payer and payee banks or financial institutions) and also request a risk assessment or score (from the risk assessment system 114). A message 532 from the payer financial institution confirms the payer account and a message 534 from the payee financial institution confirms the payee account to the payment settlement system, and in response, the payment settlement system sends a message 540 to the payer financial institution requesting a guarantee or promise to pay for the amount of the payment being made by the payer. The message 540 requesting a guarantee may include a risk score provided by the risk assessment system 114.

In response to the message 540 (assuming that payer has sufficient information to guarantee payment), a payment guarantee message 550 is sent back to the payment settlement system, which in turn sends a message 552 to the payee device that the amount is being immediately paid or deposited in the payee's account and the payee device displays a message 556 to the payee indicating the immediate availability of funds. The message 552 may also be simultaneously sent to the payee financial institution, requesting the immediate deposit to the payee's account, resulting in an account posting message 558 within the payee financial institution system that causes such immediate deposit.

After all funds have been transferred between banks at the end of the day, the payment settlement system requests by message 560 that the account management system 112 reconcile settlement accounts between the various payer and payee financial institutions or banks. After the reconciliation is performed, messages 562 are sent to each payer financial institution and payee financial institution providing settlement account balances, and indicating any amount needing to be paid by each financial institution to balance or true up (to zero) the settlement account that it has with each other financial institution.

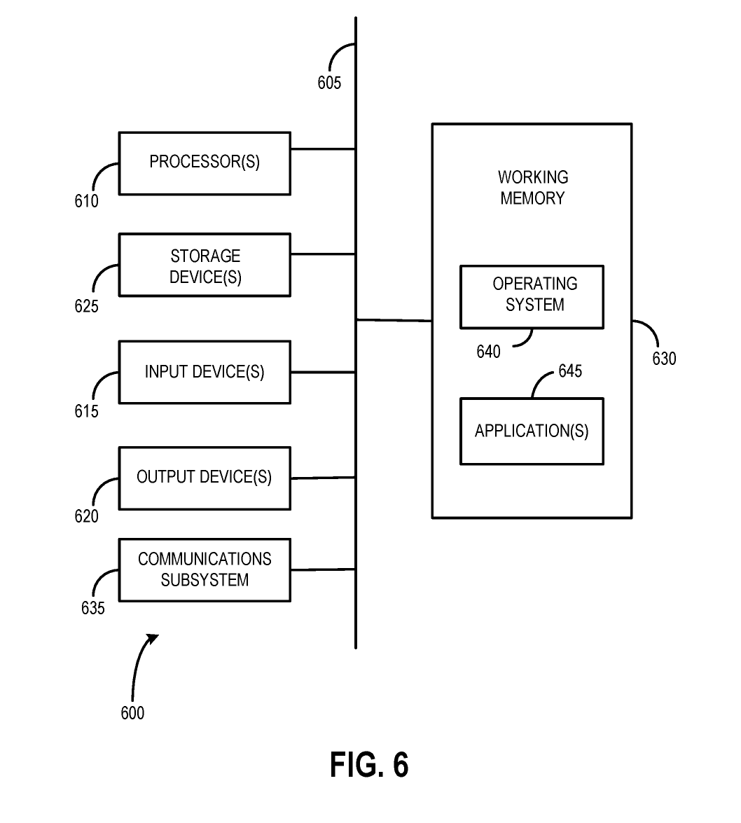

FIG. 6 is a block diagram illustrating an exemplary computer system upon which embodiments of the present invention may be implemented. This example illustrates a computer system 600 such as may be used, in whole, in part, or with various modifications, to provide the functions of the payment settlement system 100, including the payment setup system 108, the messaging system 110, the account management system 112, and the risk assessment system 114, as well as other components and functions of the invention described herein.

The computer system 600 is shown comprising hardware elements that can be electrically coupled or otherwise in communication via a bus 605. The hardware elements can include one or more processors 610, including, without limitation, one or more general-purpose processors and/or one or more special-purpose processors (such as digital signal processing chips, graphics acceleration chips, and/or the like); one or more input devices 615, which can include, without limitation, a mouse, a keyboard and/or the like; and one or more output devices 620, which can include, without limitation, a display device, a printer and/or the like.

The computer system 600 may further include one or more storage devices 625, which can comprise, without limitation, local and/or network accessible storage or memory systems having computer or machine readable media. Common forms of physical and/or tangible computer readable media include, as examples, a floppy disk, a flexible disk, hard disk, magnetic tape, or any other magnetic medium, an optical medium (such as CD-ROM), a random access memory (RAM), a read only memory (ROM) which can be programmable or flash-updateable or the like, and any other memory chip, cartridge, or medium from which a computer can read data, instructions and/or code. In many embodiments, the computer system 600 will further comprise a working memory 630, which could include (but is not limited to) a RAM or ROM device, as described above.

The computer system 600 also may further include a communications subsystem 635, such as (without limitation) a modem, a network card (wireless or wired), an infra-red communication device, or a wireless communication device and/or chipset, such as a Bluetooth® device, an 802.11 device, a WiFi device, a WiMax device, a near field communications (NFC) device, cellular communication facilities, etc. The communications subsystem 635 may permit data to be exchanged with a network, and/or any other devices described herein. Transmission media used by communications subsystem 635 (and the bus 605) may include copper wire, coaxial cables and fiber optics. Hence, transmission media can also take the form of waves (including, without limitation radio, acoustic and/or light waves, such as those generated during radio-wave and infra-red data communications).

The computer system 600 can also comprise software elements, illustrated within the working memory 630, including an operating system 640 and/or other code, such as one or more application programs 645, which may be designed to implement, as an example, the processes, messaging and displays seen in FIGS. 2-5, and thus provide specially designed and programmed devices (e.g., devices used by the payer 102 and payee 104, various systems making up the payment settlement system 100, and systems at banks 140), for carrying out the unique elements of those processes and novel features described herein.

As an example, one or more methods discussed earlier might be implemented as code and/or instructions executable by a computer (and/or a processor within a computer). In some cases, a set of these instructions and/or code might be stored on a computer readable storage medium that is part of the system 600, such as the storage device(s) 625. In other embodiments, the storage medium might be separate from a computer system (e.g., a removable medium, such as a compact disc, etc.), and/or provided in an installation package with the instructions/code stored thereon. These instructions might take the form of code which is executable by the computer system 600 and/or might take the form of source and/or installable code, which is compiled and/or installed on the computer system 600 (e.g., using any of a variety of generally available compilers, installation programs, compression/decompression utilities, etc.). The communications subsystem 635 (and/or components thereof) generally will receive the signals (and/or the data, instructions, etc., carried by the signals), and the bus 605 then might carry those signals to the working memory 630, from which the processor(s) 610 retrieves and executes the instructions. The instructions received by the working memory 630 may optionally be stored on storage device 625 either before or after execution by the processor(s) 610.

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the various systems within payment settlement system 100 may each be implemented individually or collectively by a single system having one or more storage device and processing elements. As another example, the various systems within payment settlement system 100 may each be implemented by plural systems, with their respective functions distributed across different systems either in one location or across a plurality of linked locations.

Moreover, while the various flows and processes described herein (e.g., those illustrated in FIG. 2) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A person-to-person payment system for providing payment from a payer to a payee using a mobile device of the payer, comprising:
a payment setup system programmed for:
enrolling the payer, including receiving from the payer an account identifier for identifying an account of the payer that is used to fund payment from the payer to the payee;
receiving, through a payment messaging system, a payment request message from a payer device, the payment message request including a payment amount and payee identification information, the payee identification information including at least one of a payee phone number, a payee email address and a payee mailing address;
determining whether the payee phone number and the payee email address have been provided, and whether at least one of the provided payee phone number and payee email address is usable to communicate with the payee;
upon determining that the at least one of the provided payee phone number and payee email address is not usable to communicate with the payee, determining that a payee mailing address has been provided as part of the payee identification information, and generating correspondence to the payee using the payee mailing address;
upon determining that the at least one of the provided payee phone number and payee email address is usable to communicate with a payee, sending an electronic communication through the payment messaging system to the payee device requesting that the payee select one payment method from a group of payment methods for receiving payment from the payer, the group of payment methods comprising: 1) receiving a paper check, 2) receiving a check image electronically, and 3) receiving an electronic deposit to an account of the payee;
after selection by the payee, as the one payment method, for receiving a paper check or for receiving a check image electronically, providing the paper check or the check image to the payee; and
after selection by the payee, as the one payment method, for receiving an electronic deposit to an account of the payee, receiving at the payment settlement system from a payee device an account identifier for identifying the account of the payee; and
a risk assessment system programmed for:
receiving from the payment settlement system at least the identifier for the identified account of the payer and the identifier for the identified account of the payee; and
generating, in response to receiving the identifiers for the identified account of the payer and identified account of the payee, a risk score reflecting the degree of risk associated with the requested payment from the identified account of the payer to the identified account of the payee, and providing the risk score to a first financial institution maintaining the identified account of the payer;
the payment system receiving, from the first financial institution maintaining the identified account of the payer, and in response to the risk score, a message having a payment guarantee for the amount of the payment to a second financial institution maintaining the account of the payee, the payment guarantee based at least in part on the risk score; and
with the payment guarantee provided to second financial institution maintaining the identified account of the payee in order to immediately credit the identified account of the payee with at least a portion of the amount payment.

2. The system of claim 1, wherein the payment request message from the payer device is provided without identification of the account of the payee at which the payment amount is to be credited.

3. The system of claim 1, wherein the system further comprises an account management system programmed for:
maintaining a settlement account between the first financial institution and the second financial institution, including posting as a credit to the settlement account, for the benefit second financial institution, the amount of the payment based on any guarantee from the first financial institution to the second financial institution, and posting as a credit to the settlement account, for the benefit of the first financial institution, any guarantee from the second financial institution to the first financial institution; and
reconciling the settlement account periodically, with a payment from either the first financial institution or the second financial institution, in order to true up the settlement account when the credits posted to the settlement account for one of the first and second financial institutions is greater than the credits posted to the settlement account for the other of the first and second financial institutions.

4. The system of claim 3, wherein the payment system manages a settlement account database used by the account management system to maintain the settlement account between the first financial institution and the second financial institution.

5. The system of claim 1, wherein the electronic deposit to an account of the payee is a deposit to a bank account.

6. The system of claim 1, wherein the electronic deposit to an account of the payee is a stored value account maintained at the payment system.

7. The system of claim 1, wherein the payment system manages an enrollment database for storing data received from the payer during enrollment, including the account identifier for an account of the payer that is used to fund payment from the payer to the payee.

8. The system of claim 1, wherein the payment system manages a transaction database storing transaction data relating to accounts of the payee and accounts of the payer, the transaction database used by the risk assessment system to generate the risk score reflecting the degree of risk associated with the requested payment from the payer.

9. The system of claim 1, wherein the payment system includes a messaging system for managing messages between the payment system and each of the payer device, a payee device, a system of the first financial institution maintaining the account of the payer, and the second financial institution maintaining the account of the payee, the messaging system generating messages for:
requesting payer account information from the payer, requesting payment selection from the payee reflecting the method of payment preferred by the payee, requesting confirmation of the payer account and payee account from the first financial institution of the payer and the second financial institution of the payee, requesting the promise to pay from the first financial institution of the payer, receiving the promise to pay from the first financial institution of the payer, and notifying the payee of immediate crediting to the account of the payee upon receipt of the promise to pay.

10. The system of claim 1, wherein the payment setup system determines whether at least one of the payee phone number and the payee email address is usable by accessing third party telephone and email address databases external to the payment system.

11. A method for providing payment from a payer to a payee using a mobile device of the payer, comprising:
enrolling, at a payment settlement system, the payer, including receiving from the payer an account identifier for an account of the payer that is used to fund payment from the payer to the payee;
receiving, at the payment settlement system, a payment request message from a payer device, the payment message request including a payment amount and payee identification information, the payee identification information including at least one of a payee phone number, a payee email address and a payee mailing address;
determining at the payment settlement system whether the payee phone number and the payee email address have been provided, and whether at least one of the payee phone number and the payee email address is usable to communicate with the payee;
if the at least one of the payee phone number and the payee email address is not usable to communicate with the payee, determining that a payee mailing address has been provided as part of the payee identification information, and generating correspondence to the payee using the payee mailing address;
if the at least one of the payee phone number or payee email address is usable to communicate with a payee, sending an electronic communication from a messaging system at the payment settlement system to the payee requesting that the payee select one payment method from a group of payment methods for receiving payment from the payer, the group of payment methods comprising: 1) receiving a paper check, 2) receiving a check image electronically, and 3) receiving an electronic deposit to an account of the payee;
if the payee selects, as the one payment method, either receiving a paper check or receiving a check image electronically, then providing the paper check or the check image to the payee;
if the payee selects, as the one payment method, receiving an electronic deposit to an account of the payee, then:
receiving, at the payment settlement system from a payee device, an account identifier for the account of the payee;
generating, at a risk assessment system at the payment settlement system, a risk score reflecting the degree of risk associated with the requested payment from the payer;
receiving, at the payment settlement system from a financial institution maintaining the account of the payer, a promise to pay the amount of the payment to a financial institution maintaining the account of the payee, the promise to pay based at least in part on the risk score; and
in response to receiving the promise to pay, immediately crediting to the account of the payee the amount of the payment.

12. The method of claim 11, wherein the payment request message from the payer device is provided without identification of the account of the payee at which the payment amount is to be credited.

13. The method of claim 11, wherein the account of the payer is maintained at one of a first financial institution and a second financial institution, and the account of the payee is maintained at the other of the first financial institution and the second financial institution, and wherein the method further includes:
maintaining, at an account management system at the payment settlement system, a settlement account between the first financial institution and the second financial institution, and posting as a credit to the settlement account for the benefit second financial institution the amount of the payment based on the promise to pay from the first financial institution to the second financial institution, and posting as a credit to the settlement account, for the benefit of the first financial institution, an amount of a payment based on a promise to pay from the second financial institution to the first financial institution; and
reconciling the settlement account periodically, with a payment from either the first financial institution or the second financial institution, in order to true up the settlement account when the credits posted to the settlement account for one of the first and second financial institutions is greater than the credits posted to the settlement account for the other of the first and second financial institutions.

14. The method of claim 13, wherein the payment settlement system manages a settlement account database used by the account management system to maintain the settlement account between the first financial institution and the second financial institution.

15. The method of claim 11, wherein the electronic deposit to an account of the payee is a deposit to a bank account.

16. The method of claim 11, wherein the electronic deposit to an account of the payee is a stored value account maintained at the payment settlement.

17. The method of claim 11, wherein the payment settlement system manages an enrollment database for storing data received from the payer during enrollment, including the account identifier for an account of the payer that is used to fund payment from the payer to the payee.

18. The method of claim 11, wherein the payment settlement system manages a transaction database storing transaction data relating to accounts of the payee and accounts of the payer, and used by the risk assessment system to generate the risk score reflecting the degree of risk associated with the requested payment from the payer.

19. The method of claim 11, wherein the payment settlement system includes a messaging system for managing messages between the payment settlement system at each of the payer device, a payee device, a system of the financial institution maintaining the account of the payer, and the financial institution maintaining the account of the payee, the messaging system generating messages for:
requesting payer account information from the payer, requesting payment selection from the payee reflecting the method of payment preferred by the payee, requesting confirmation of the payer account and payee account from the financial institution of the payer and the financial institution of the payee, requesting a payment guarantee from the financial institution of the payer, receiving a payment guarantee from the financial institution of the payer, and notifying the payee of immediate crediting to the account of the payee upon receipt of the payment guarantee.

20. The method of claim 11, wherein the payment setup system determines whether at least one of the payee phone number and the payee email address is usable by accessing third party telephone and email address databases external to the payment system.
